(19) United States
(12) Patent Application Publication
(10) Pub. No.: US 2025/0042227 A1
(43) Pub. Date: Feb. 6, 2025

(54) Actuating Mechanism for Actuating a Plurality of Air-Guiding Elements of an Air Vent for a Vehicle, as well as Air Vents Having Such an Actuating Mechanism

(71) Applicant: Illinois Tool Works Inc., Glenview, IL (US)

(72) Inventors: Laurent LE TOHIC, Enkenbach-Alsenborn (DE); Joachim PESTKE, Enkenbach-Alsenborn (DE)

(21) Appl. No.: 18/767,061

(22) Filed: Jul. 9, 2024

(30) Foreign Application Priority Data
Aug. 4, 2023 (DE) 10 2023 120 788.1

(51) Int. Cl. B60H 1/34

(52) U.S. Cl. CPC B60H 1/3421; B60H 2001/3471

(57) ABSTRACT

The disclosure relates to an actuating mechanism (1) for actuating a plurality of first air-guiding elements (3) of an air vent, each of which are borne about a respective first pivot axis (2). Each first air-guiding element (3) includes an integrally formed bearing element (4) extending eccentrically to the pivot axis (2) of the respective air-guiding element (3). The actuating mechanism (1) includes a manually actuatable actuating element (5) and a coupling structure (6) operatively connected to the actuating element (5). The actuating element (5) is slidably borne in a second direction (7) extending perpendicular to the longitudinal extension direction (14) of the first air-guiding elements (3), and the coupling structure (6) is configured so as to receive the bearing elements (4) of the first air-guiding elements (3) in such a way that a movement of the actuating element (5) in the second direction (7) extending perpendicular to the longitudinal extension direction (14) of the first air-guiding elements (3) can be transferred to the bearing elements (4), but not a movement of the actuating element (5) in the longitudinal extension direction (14) of the first air-guiding elements (3) or a movement of the actuating element (5) perpendicular to the longitudinal extension direction (14) of the first air-guiding elements (3) and perpendicular to the second direction (7) or a rotational movement of the actuating element (5) about an axis of rotation extending parallel to the second direction (7).

### RELATED APPLICATION

The present application claims the benefit of German Patent Application No. 10 2023 120 788.1, filed Aug. 4, 2023, titled “Actuating Mechanism for Actuating a Plurality of Air-Guiding Elements of an Air Vent for a Vehicle, as well as Air Vents Having Such an Actuating Mechanism,” the contents of which are hereby incorporated by reference.

### BACKGROUND

In ventilation apparatuses for vehicles, air vents or air vent nozzles are typically used, which enable the exiting airflow to be controlled in a targeted manner. Such air vents are used in order to supply fresh air, in particular, into a motor vehicle interior.

The airflow flows through an inlet opening at an air inlet region of the air vent into the air channel, which is delimited by the housing wall of the air vent, through said air channel, and ultimately through an outlet opening at the air outlet region of the air vent into the interior of a motor vehicle (for example, a car or truck). The airflow generally follows a main flow direction, which can run in particular at least substantially parallel to a longitudinal axis of the housing of the air vent.

In known air vents, the airflow is deflected from the main flow direction by one or more air-guiding elements, for example pivotable air-guiding blades. In addition to the air-guiding elements, the housing of the air vent that delimits the air channel can also serve to deflect the air from the main flow direction.

For example, air vents are known whose housing walls run arcuately in the direction of one another at least at the air inlet region, wherein an airflow directed by an air-guiding element in the direction of the arcuate housing wall follows the arc shape and thus undergoes a corresponding deflection.

Such air vents are known, for example, from DE 20 2015 102 026 U1 and DE 10 2017 111 011 A1.

In addition, reference is made to DE 20 2013 012 285 U1. In the air vent known from this prior art, two mutually opposite housing walls of the air vent housing are designed in an arcuate fashion. An air-guiding element having a first air-guiding surface and a second air-guiding surface opposite the first air-guiding surface is arranged in the air vent housing, wherein a first air channel is formed by the housing and the first air-guiding surface, and a second air channel is formed by the housing and the second air-guiding surface. The first air channel is configured in order to transport a first volumetric flow of air that can be passed into the housing through the air inlet opening to the air vent opening, while the second air channel is configured in order to transport a second volumetric flow of air that can be passed into the housing through the air inlet opening to the air vent opening.

In addition, in the air vent known from DE 20 2013 012 285 U1, a wing element is arranged in the housing, wherein the wing element is movably arranged in an air inlet section between the air inlet opening and the end of the air-guiding element facing said opening. The movability of the wing element is configured such that the direction of the air exiting the air vent opening is adjusted due to the position of the wing element.

However, due to the arcuate design of the housing wall, such air vents are quite complex to manufacture, in particular by way of a plastic injection molding method.

Furthermore, the air vent known from DE 20 2013 012 285 U1 has certain disadvantages, in particular with respect to the overall achievable throughput of the amount of air to be introduced into the interior of the vehicle.

In particular, the operation of the air vent known from DE 20 2013 012 285 U1 is based on the air deflection being achieved by varying the volumetric flows (first and second volumetric flow) through the two air channels formed using the air-guiding element. By adjusting or varying the ratio of the volumetric flows flowing through the first and second air channels of the known air vent, a desired air deflection of the air streaming out of the air outlet region of the air vent is substantially performed.

However, it has been shown that such a mechanism for causing air deflection reduces the performance of the air vent, i.e. the volumetric flow that can be emitted by the air vent per unit of time and/or the “quality” of the airflow that can be emitted by the air vent, in particular with regard to airflow fanning and direction. Above all, with the approach known from DE 20 2013 012 285 U1, for example, an evenly distributed volumetric flow at the air outlet region of the air vent cannot be achieved for different positions of the air vent.

Apart from these disadvantages, the air vent known from DE 20 2013 012 285 U1, in particular, has conceptual disadvantages in terms of air deflection.

For example, even in the straight alignment of the air-guiding elements, the known air vents often divert or deflect the air repeatedly within the housing of the air vent, which results in an increased flow resistance. The effect of the air-guiding elements accommodated in the housing of the air vent is thereby significantly impaired, in particular for horizontal air deflection.

In addition, due to the increased flow resistance upstream of the outlet opening of the air vent, the exiting airflow is widened, which is also generally not desired.

A further disadvantage of known air vents is that the air-guiding elements arranged in the air channel, such as air-guiding blades, limit the flow region that is available for the air. This is true in particular in the region of the end positions of the air-guiding elements. Limitations of the available flow region of more than 50% can occur.

In addition, for design reasons, there is a partial desire to integrate the outlet openings of the air vents harmoniously into the overall I-board design as slit-like openings in such a way that the functional elements of the air vents, in particular the blades, are not directly discernible from the vehicle interior.

Because air vents are directly visible in the interior of the vehicle, they are also intended to have an optically appealing appearance. In particular, there is therefore a need to adapt the design and appearance of air vents to the interior atmosphere. To this end, air vents are known that have a relatively low height compared to their length. However, air deflection in such slitted vents is typically limited.

In order to achieve a defined air deflection, the air vents known from the prior art therefore generally have a height such that a certain number of air-guiding blades can be arranged. The number of air-guiding blades thus also defines the maximum deflection.

However, there are problems with air deflection accomplished via the air-guiding blades, which extend across the width of the air vent. In such air vents, only a small width of the air-guiding blades, usually a maximum of three air-guiding blades, can often be arranged. The maximum air deflection is thus limited.

For construction-related reasons, air vents having an even lower height can only comprise one air-guiding blade extending across the width of the air vent. However, there is then insufficient air deflection, in particular in the vertical direction, i.e. up and down.

Based on this situation, the problem addressed by the present disclosure is thus to specify an air vent for a vehicle having a correspondingly optimized actuating mechanism.

In addition, an air vent is to be specified, in which, with regard to manufacture and assembly, a particularly simple servicing of the air-guiding elements of the air vent is enabled, namely with only a single actuating element, wherein a jamming or wedging of the actuating element upon its actuation is effectively prevented. In addition, the optical appearance of the air vent is intended to be as reserved as possible.

### SUMMARY

The present disclosure relates generally to an air vent and/or air vent having an actuating mechanism, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically illustrates the basic construction of an exemplary embodiment of the air vent according to the disclosure, having an actuating mechanism of the type according to the disclosure.

FIG. 2 illustrates schematically and in an isometric rear view, an interior component of an exemplary embodiment of the air vent according to the disclosure.

FIG. 3 illustrates schematically and in an isometric view, the interior component according to FIG. 2.

FIG. 4 illustrates schematically and in a further isometric view, the interior component according to FIG. 2.

FIG. 5 illustrates schematically and in an isometric partially cut view, the interior component according to FIG. 2.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to air vents, in particular for a ventilation system of a motor vehicle, as well as ventilation systems having such air vents. Specifically, the present disclosure relates in particular to an optimized actuating mechanism for as-needed actuation and in particular pivoting of corresponding air-guiding elements of the air vent.

Accordingly, the disclosure relates in particular to an actuating mechanism for as-needed actuation and in particular pivoting of a plurality of first air-guiding elements of an air vent for a vehicle that are borne about a first pivot axis. Each first air-guiding element comprises a bearing element molded onto the respective air-guiding element and extending eccentrically to the pivot axis of the respective air-guiding element, in particular at least regionally in the form of a bearing pin.

The actuating mechanism comprises a manually actuatable actuating element and a coupling structure operatively connected to the actuating element. The actuating element is slidably mounted in a second direction extending perpendicular to the longitudinal extension direction of the first air-guiding elements.

The coupling structure is configured so as to at least partially or regionally receive the bearing elements of the first air-guiding elements in such a way that a movement of the actuating element in the second direction extending perpendicular to the longitudinal extension direction of the first air-guiding elements is or can be transferred to the bearing elements, but not a movement of the actuating element in the longitudinal extension direction of the first air-guiding elements and/or a movement of the actuating element perpendicular to the longitudinal extension direction of the first air-guiding elements and perpendicular to the second direction and/or a rotational movement of the actuating element about an axis of rotation extending parallel to the second direction.

In order to realize such a coupling structure, it is contemplated that the coupling structure is configured as a comb or tooth structure, which comprises a serration, wherein, between two teeth of the serration that are adjacent to one another, a respective bearing element of the first air-guiding elements is or can be at least partially or regionally accommodated.

In this context, it is particularly expedient that an intermediate region defined between two teeth of the serration that are adjacent to one another forms a bearing region for a bearing element of one of the first air-guiding elements. In particular, the bearing region is configured so as to reduce the freedom of movement of the bearing element, which is at least partially or regionally accommodated in the bearing region, by exactly one degree. This precisely one degree of freedom of movement is in particular a movement of the bearing element accommodated at least partially or regionally in the bearing region in the second direction extending perpendicular to the longitudinal extension direction of the first air-guiding elements.

The coupling structure and at least one base body of the actuating element are preferably configured as a monolithic component, in particular a plastic injection-molded part.

According to realizations of the actuating mechanism according to the disclosure, it can be provided that at least the coupling structure of the actuating mechanism is at least partially or regionally accommodated in the interior of an airflow splitter. In particular, the airflow splitter is configured so as to divide an airflow flowing through the air vent into a first air channel and into a second air channel. Preferably, each first air-guiding element comprises a first air-guiding region accommodated in the first air channel and a second air-guiding region accommodated in the second air channel.

In order to transfer a movement from the bearing pin to the corresponding air-guiding regions of the first air-guiding elements, each bearing element of the first air-guiding elements must be connected to a bearing pin of the first and second air-guiding region of the corresponding air-guiding element via a lever arm region, respectively.

In order to limit a movement of the actuating element in the second direction, i.e. in the direction extending perpendicular to the longitudinal extension direction of the first air-guiding elements, it is provided according to realizations of the present disclosure that at least one stop is associated with the actuating element.

Preferably, the actuating mechanism is further configured so as to actuate and in particular to pivot, as needed, at least one second air-guiding element of the air vent, which is pivotally mounted about a second pivot axis extending perpendicular to the first pivot axis.

In this further development of the actuating mechanism according to the disclosure, it is provided in particular that the actuating element is slidably borne relative to the at least one second air-guiding element in the longitudinal extension direction of the at least one second air-guiding element.

In particular, in this context, it is contemplated that the actuating element is borne in a slidable manner relative to the second air-guiding element on or atop the at least one second air-guiding element in the longitudinal extension direction of the second air-guiding element.

The air vent according to the disclosure comprises a housing with an air inlet region and an opposite air outlet region, a plurality of first air-guiding elements pivotably borne relative to the housing about a first pivot axis, and an actuating mechanism of the manner according to the disclosure as described above, wherein the actuating mechanism is configured for the as-needed actuation and in particular pivoting of the first air-guiding elements, which are in particular configured in the form of air-guiding shells.

According to further developments of the air vent according to the disclosure, it is provided that the air vent further comprises an airflow splitter that is accommodated at least regionally in the housing of the air vent such that, at least regionally, an air channel delimited or defined by the housing is divided into a first air channel and into a second air channel separated therefrom.

For the as-needed air deflection in a first direction, in particular in a horizontal direction, first air-guiding regions of the first air-guiding elements are pivotably accommodated in the first air channel and second air-guiding regions of the first air-guiding elements are pivotably accommodated in the second air channel, respectively relative to the housing, about the pivot axis of the respective air-guiding elements.

In this context, it is expedient that the actuating mechanism, and in particular the coupling structure of the actuating mechanism, is received at least partially or regionally within the airflow splitter.

According to aspects of the air vent according to the disclosure, for the purpose of deflecting air as needed in a second direction, in particular in a vertical direction, the air vent comprises at least one air-guiding element pivotably borne relative to the housing about a second pivot axis that extends perpendicular to the first pivot axis. This at least one second air-guiding element is preferably arranged at least regionally downstream of the first air-guiding elements, when viewed in the main flow direction of the air vent.

Preferably, the air vent comprises exactly one single second air-guiding element in order to reduce the construction height of the air vent.

In this context, it is expedient that the actuating element is slidably borne relative to the second air-guiding element on or at the at least one second air-guiding element and in particular on or at the exactly one second air-guiding element in the longitudinal extension direction of the second air-guiding element.

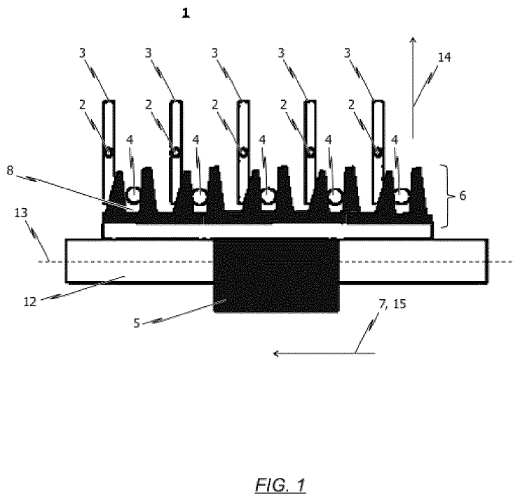

Firstly, in the following, an exemplary aspect of the air vent according to the disclosure and the actuating mechanism 1 as used in the air vent according to the disclosure is described in further detail with reference to the drawing in FIG. 1.

Specifically, the view shown schematically in FIG. 1 shows components of an air vent for a vehicle.

The air vent comprises in principle a housing (not shown in FIG. 1) having an air inlet region and an opposite air outlet region. The housing not explicitly shown in FIG. 1 limits or defines an air channel that flows through the air vent.

Corresponding air-guiding elements 3, 12 are used for the as-needed deflection of the airflow flowing through the air channel of the air vent.

In the exemplary aspect shown in FIG. 1, a plurality of first air-guiding elements 3 arranged parallel to one another are used for the as-needed deflection of the airflow flowing through the air vent in a horizontal direction. The first air-guiding elements 3 are each pivotably mounted relative to the housing about a first pivot axis 2.

In the design variant shown schematically in FIG. 1, a second air-guiding element 12 in the form of a front air-guiding blade is also used. This second air-guiding element 12 serves for the as-needed deflection of the airflow flowing through the air vent in a vertical direction.

As can be seen from the illustration in FIG. 1, the second air-guiding element 12 is arranged downstream of the second air-guiding elements 3, when viewed in the main flow direction.

The second air-guiding element 12 is pivotally mounted relative to the housing about a second pivot axis 13. The second pivot axis 13 extends perpendicular to the first pivot axes 2, about which the first air-guiding elements 3 are pivotally borne relative to the housing.

In order to deflect/pivot the first air-guiding elements 3 and/or the second air-guiding element 12 from their neutral position as shown in FIG. 1 as needed, a corresponding actuating mechanism 1 is used.

The actuating mechanism 1 comprises a manually actuatable actuating element 5 and a coupling structure 6 operatively connected to the actuating element 5. The actuating element 5 is slidably mounted in a second direction 7 extending perpendicular to the longitudinal extension direction 14 of the first air-guiding elements 3. The longitudinal extension direction 14 of the first air-guiding elements 3 corresponds to the direction in which the first pivot axes 2 of the first air-guiding elements 3 extend.

The coupling structure 6 operatively connected to the actuating element 5 is configured so as to transfer to the first air-guiding elements 3 a movement of the actuating element 5 in the second direction 7 extending perpendicular to the longitudinal extension direction 14 of the first air-guiding elements 3.

In the same manner, the coupling structure 6 is configured so as to not transfer to the corresponding first air-guiding elements 3 a movement of the actuating element 5 in the longitudinal extension direction 14 of the first air-guiding elements 3 and/or a movement of the actuating element 5 perpendicular to both the longitudinal extension direction 14 of the first air-guiding elements 3 and the second direction 7 and/or a rotational movement of the actuating element 5 about a rotational axis extending parallel to the second direction 7.

In other words, the coupling structure 6 provides a somewhat “floating” bearing of the bearing elements 4 associated with the respective first air-guiding elements 3. These bearing elements 4 are correspondingly molded onto the respective first air-guiding element 3 and extend eccentrically to the pivot axis 2 of the corresponding first air-guiding element 3 are are in particular at least regionally configured in the form of a bearing pin.

The bearing elements for the coupling structure 6 of the actuating mechanism 1 are preferably configured as a fixed bearing/loose bearing combination.

Specifically, the schematic view of FIG. 1 shows that the coupling structure 6 of the actuating mechanism 1 is configured as a comb or tooth structure. This comb or tooth structure 6 comprises a serration, wherein, between two teeth of the serration that are adjacent to one another, a respective bearing element 4 of the first air-guiding elements 3 is or can be at least partially or regionally accommodated.

In detail, the schematic view according to FIG. 1 shows that an intermediate region defined between two teeth of the comb or tooth structure of the coupling structure 6 that are adjacent to one another forms a bearing region 8 for a bearing element 4 of one of the first air-guiding elements 3.

In particular, it is provided here that the bearing region 8 is configured so as to reduce the freedom of movement of the bearing element 4, which is at least partially or regionally accommodated in the bearing region 8, by exactly one degree. The precisely one degree of freedom of movement is in particular a movement of the bearing element 4 accommodated at least partially or regionally in the bearing region 8 in the second direction 7 extending perpendicular to the longitudinal extension direction 14 of the first air-guiding elements 3.

It can further be seen in the illustration in FIG. 1 that the actuating element 5 of the actuating mechanism 1 is preferably arranged in the center of the coupling structure 6. By contrast to the solutions known from the prior art, the actuating mechanism 1 is characterized in that no coupling rods, etc. are used.

Preferably, the coupling structure 6 is monolithically formed with at least one base body of the actuating element 5, in particular as a common plastic injection-molded part, which can also be configured regionally as a hollow body, in order to thus reduce the weight of the actuating mechanism 1.

The design variant of the actuating mechanism 1 according to the disclosure shown schematically in FIG. 1 is further characterized in particular in that the actuating mechanism 1 is configured so as to actuate and in particular to pivot the second air-guiding element 12 of the air vent, which is pivotably mounted about the second pivot axis 13 that extends perpendicularly to the first pivot axis 2.

In particular, it is provided that the actuating element 5 is slidably borne relative to the second air-guiding element 12 in the longitudinal extension direction 15 of the second air-guiding element 12. In other words, the second air-guiding element 12 can serve as a type of “guide” for the actuating element 5.

In this case, the actuating element 5 is pivoted along with the second air-guiding element 12 about the second pivot axis 13 when the second air-guiding element 12 is pivoted about the second pivot axis 13, in order to, for example, cause an air deflection in the vertical direction. Because the actuating element 5 is preferably integrally connected to the coupling structure 6 of the actuating mechanism 1, the coupling structure 6, and in particular the comb or tooth structure that primarily forms the coupling structure 6, is thus also pivoted relative to the bearing elements 4 of the first air-guiding elements 3, namely about the second pivot axis 13, about which the second air-guiding element 12 can also be pivoted.

However, this pivoting of the coupling structure 6 relative to the bearing elements 4 of the first air-guiding elements 3 does not negatively affect the coupling of the actuating element 5, because, as already stated, the bearing elements 4 of the first air-guiding elements 3 are in a certain sense “floatingly” accommodated in the bearing regions 8 formed by the tooth structure of the coupling structure 6.

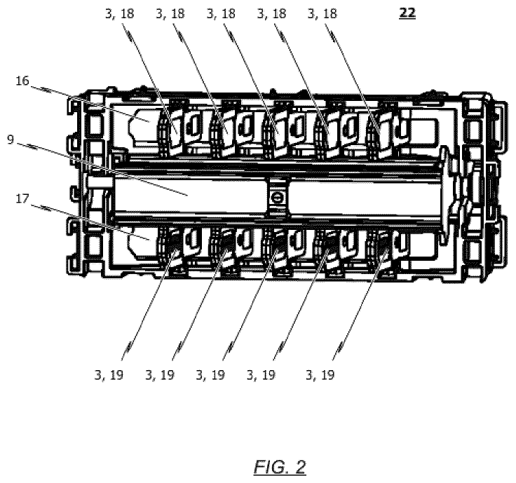

A specific design of the actuating mechanism 1 according to the disclosure is described in further detail below with reference to the drawings in FIG. 2 to FIG. 5.

Specifically, in FIG. 2 to FIG. 5 (in a partially cut view), a component of the air vent according to the disclosure is shown. This component is at least regionally receivable in a housing (not shown in FIG. 2 to FIG. 5) and can preferably be fixed to the housing there via a latching, centering, and/or clipping connection 21. In particular, the air vent in question is one that is “modularly” constructed in a certain sense, in which an interior module can be replaced or exchanged at least regionally or partially in the housing of the air vent and can be fixed therein.

The interior module 22 of the air vent described below with reference to the illustrations in FIG. 2 to FIG. 5 comprises a plurality of first air-guiding elements 3 pivotably mounted relative to the housing (not shown) about a first pivot axis 2. These are in particular air-guiding shells. Each first air-guiding element 3 is formed by a first air-guiding region 18 as well as a second air-guiding region 19.

In the design variant shown schematically in FIG. 2 to FIG. 5, an airflow splitter 9 is used, which is at least partially or regionally accommodated in the interior of the housing of the air vent. With the aid of the airflow splitter 9, an airflow flowing through the air vent is divided into a first air channel 16 and into a second air channel 17. It is provided here that the first air-guiding regions 18 of the first air-guiding elements 3 are accommodated at least partially or regionally in the first air channel 16 and the second air-guiding regions 19 of the first air-guiding elements 3 at least partially or regionally in the second air channel 17.

The air-guiding regions 18, 19 of the first air-guiding elements 3 are pivotally borne relative to the housing of the air vent about a first pivot axis 2 via corresponding bearing elements 4.

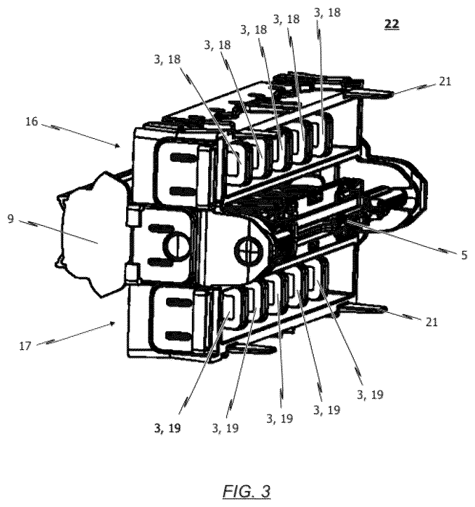

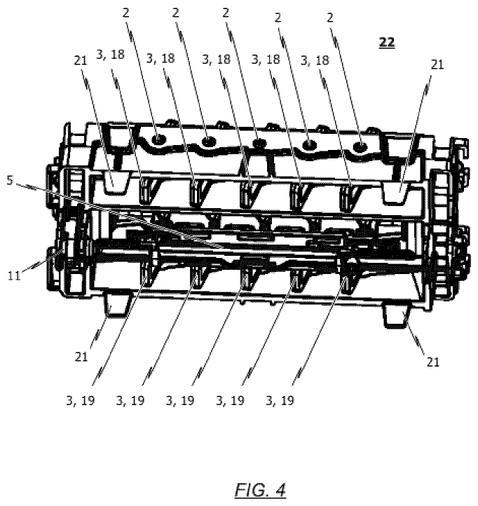

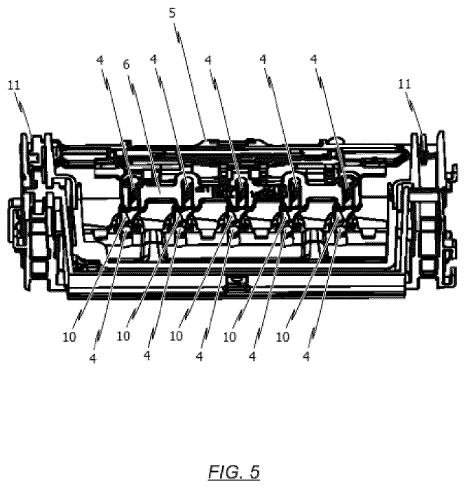

As can be seen in particular, for example, from the isometric views in FIG. 3, FIG. 4, and FIG. 5, at least the coupling structure 6 of the actuating mechanism 1 is at least partially or regionally accommodated in the interior of the airflow splitter 9.

However, the disclosure is not limited to air vents that are equipped with such an airflow splitter 9. The actuating mechanism 1 according to the disclosure is similarly suitable for air vents without airflow splitters 9.

The comb or tooth structure 6 of the coupling structure 6 with the serration, in which a respective bearing element 4 of the first air-guiding elements 3 is at least partially or regionally accommodated between two adjacent teeth, can in particular be seen from the isometric, partially cut view according to FIG. 5.

In particular in the design variant shown in FIG. 1, it is provided that the air vent comprises exactly one single second air-guiding element 12. However, this is not to be construed as limiting. Rather, it is also contemplated that, as indicated in FIG. 2 to FIG. 5, the air vent does not comprise a second air-guiding element 12. On the other hand, however, it is also contemplated that the air vent comprises a plurality of second air-guiding elements 12 that extend parallel to one another.

For example, the illustration in FIG. 4 shows that a stop 11 is associated with the actuating element 5 in order to limit a movement of the actuating element 5 in the second direction 7, i.e. in the direction extending perpendicular to the longitudinal extension direction 14 of the first air-guiding elements 3.

The disclosure is not limited to the design variants shown in the drawings, but results when all of the features disclosed herein are considered together.

### LIST OF REFERENCE NUMERALS

1 Actuating mechanism
2 First pivot axis
3 First air-guiding elements
4 Bearing element
5 Actuating element
6 Coupling structure/comb or tooth structure
7 Second direction
8 Bearing region
9 Airflow splitter
10 Lever arm region
11 Stop
12 Second air-guiding elements
13 Second pivot axis
14 Longitudinal extension direction of the first air-guiding elements
15 Longitudinal extension direction of the second air-guiding element
16 First air channel
17 Second air channel
18 First air-guiding region
19 Second air-guiding region
21 Latching/clipping connection
22 Inner module of the air vent

What is claimed is:

1. An actuating mechanism (1) for actuating a plurality of first air-guiding elements (3) of an air vent for a vehicle, each of which are borne about a respective first pivot axis (2),
wherein each first air-guiding element (3) comprises a bearing element (4) integrally formed on the respective air-guiding element (3) and extending eccentrically to the pivot axis (2) of the respective air-guiding element (3), in particular in the form of a bearing pin at least in regions,
wherein the actuating mechanism (1) comprises an actuating element (5), which is in particular manually actuatable, and a coupling structure (6) operatively connected to the actuating element (5),
wherein the actuating element (5) is slidably borne in a second direction (7) extending perpendicular to a longitudinal extension direction (14) of the first air-guiding elements (3), and
wherein the coupling structure (6) is configured so as to receive, at least partially or regionally, the bearing elements (4) of the first air-guiding elements (3) in such a way that a movement of the actuating element (5) in the second direction (7) extending perpendicular to the longitudinal extension direction (14) of the first air-guiding elements (3) is or can be transferred to the bearing elements (4), but not a movement of the actuating element (5) in the longitudinal extension direction (14) of the first air-guiding elements (3) or a movement of the actuating element (5) perpendicular to the longitudinal extension direction (14) of the first air-guiding elements (3) and perpendicular to the second direction (7) or a rotational movement of the actuating element (5) about an axis of rotation extending parallel to the second direction (7).

2. The actuating mechanism (1) according to claim 1,
wherein the coupling structure (6) is configured as a comb or tooth structure, which comprises a serration, wherein, between two teeth of the serration that are adjacent to one another, a respective bearing element (4) of the first air-guiding elements (3) is or can be at least partially or regionally received.

3. The actuating mechanism (1) according to claim 2,
wherein an intermediate region defined between two teeth of the serration that are adjacent to one another forms a bearing region (8) for a bearing element (4) of one of the first air-guiding elements (3), wherein the bearing region (8) is configured so as to limit exactly one degree of freedom of movement of the bearing element (4) received at least partially or regionally in the bearing region (8), wherein the exactly one degree of freedom of movement is a movement of the bearing element (4) received at least partially or regionally in the bearing region (8) in the second direction (7) extending perpendicular to the longitudinal extension direction (14) of the first air-guiding elements (3).

4. The actuating mechanism (1) according to claim 1,
wherein the coupling structure (6) and at least one base body of the actuating element (5) are configured as a monolithic component, in particular a plastic injection-molded part.

5. The actuating mechanism (1) according to claim 1,
wherein at least the coupling structure (6) of the actuating mechanism (1) is received at least partially or regionally inside an airflow splitter (9), wherein the airflow splitter (9) is configured so as to split a stream of air flowing through the air vent into a first air channel (16) and into a second air channel (17), wherein each first air-guiding element (3) comprises a first air-guiding region (18) received in the first air channel (16) and a second air-guiding region (19) received in the second air channel (17).

6. The actuating mechanism (1) according to claim 5,
wherein each bearing element (4) of the first air-guiding elements (3) is connected to a bearing element (4) of the first and second air-guiding region (18, 19) of a corresponding air-guiding element (3) via a respective lever arm region (10).

7. The actuating mechanism (1) according to claim 1,
wherein at least one stop (11) is associated with the actuating element (5) for limiting a movement of the actuating element (5) in the second direction (7).

8. The actuating mechanism (1) according to claim 1,
wherein the actuating mechanism (1) is further configured so as to actuate, and in particular pivot, as needed at least one second air-guiding element (12) of the air vent that is pivotably borne about a second pivot axis (13) extending perpendicular to the first pivot axis (2), wherein the actuating element (5) is borne in the longitudinal extension direction (14) of the at least one second air-guiding element (12) in a slidable manner relative to the at least one second air-guiding element (12).

9. The actuating mechanism (1) according to claim 8,
wherein the actuating element (5) is borne on or atop the at least one second air-guiding element (12) in the longitudinal extension direction (14) of the second air-guiding element (12) in a slidable manner relative to the second air-guiding element (12).

10. An air vent for a motor vehicle, wherein the air vent comprises the following:
a housing having an air inlet region and an opposite air outlet region;
a plurality of first air-guiding elements (3), in particular in the form of air-guiding shells, each borne pivotably relative to the housing about a respective first pivot axis (2); and
an actuating mechanism (1) according to claim 1, wherein the actuating mechanism (1) is configured so as to actuate, and in particular to pivot, the first air-guiding elements (3) together as needed.

11. The air vent according to claim 10,
wherein the air vent further comprises an airflow splitter (9) that is at least partially or regionally received in the housing such that, at least regionally, an air channel limited or defined by the housing is split into a first air channel (16) and into a second air channel (17) separated therefrom, wherein, for the as-needed air deflection in a first direction, in particular in a horizontal direction, first air-guiding regions (18) of the first air-guiding elements (3) in the first air channel (16) and second air-guiding regions (19) of the first air-guiding elements (3) in the second air channel (17) are respectively received pivotably relative to the housing about the pivot axis (2) of the corresponding air-guiding elements (3).

12. The air vent according to claim 11,
wherein the actuating mechanism (1), and in particular the coupling structure (6) of the actuating mechanism (1), are at least partially or regionally received within the airflow splitter (9).

13. The air vent according to claim 10,
wherein, for the as-needed air deflection in a second direction (7), in particular in a vertical direction, the air vent comprises at least one air-guiding element (12) pivotably borne relative to the housing about a second pivot axis (13) extending perpendicular to the first pivot axis (2), wherein the at least one second air-guiding element (12) is arranged at least regionally downstream of the first air-guiding elements (3), when viewed in the main flow direction of the air vent.

14. The air vent according to claim 13,
wherein the air vent comprises exactly one second air-guiding element (12).

15. The air vent according to claim 13,
wherein the actuating element (5) is borne in a slidable manner relative to the second air-guiding element (12) on or atop the at least one second air-guiding element (12) in the longitudinal extension direction (15) of the second air-guiding element (12).
